(19) United States
(12) Patent Application Publication
(10) Pub. No.: US 2004/0177256 A1
(43) Pub. Date: Sep. 9, 2004

(54) Semiconductor apparatus

(76) Inventor: Shinichiro Kobayashi, Hino-shi (JP)

Correspondence Address: HARNESS, DICKEY & PIERCE, P.L.C., P.O. BOX 828, BLOOMFIELD HILLS, MI, 48303, US

(21) Appl. No.: 10/755,120

(22) Filed: Jan. 9, 2004

(30) Foreign Application Priority Data
Jan. 9, 2003 (JP) 2003-002831

(51) Int. Cl. H04L 9/00

(52) U.S. Cl. 713/189

(57) ABSTRACT

A semiconductor apparatus is provided that includes memories for storing an externally input key or data at a received address, key comparison sections for comparing the externally input key with keys output from the memories, a first-hash-function calculation section for associating the externally input key with a first address in many-to-one correspondence, a second-hash-function calculation section for associating the first address with a second address in one-to-one correspondence, a data writing processing section for sending the first or second address to the memories to store data, and a data reading processing section for sending the first or second address to the memories to read data.

### BACKGROUND OF THE INVENTION

1. Technical Field of the Invention

The present invention relates to semiconductor apparatuses for storing keys and data.

2. Description of the Related Art

A technology for reading data stored in a memory, at a high speed, called hashing has been conventionally used. In this technology, (i) data is associated with a key which uniquely identifies the data, (ii) the key is converted by a function (called a hash function), and the obtained result is used as an address for storing the key and data, and (iii) the key and data are stored at the address. In data reading, a key is converted by the hash function to an address, and data stored at the address is read.

In general, since many inputs correspond to one output in hash functions, a plurality of different keys may be converted to one address (hereinafter called address coincidence). To prevent such address coincidence, it is preferred to use a hash function which converts keys to addresses uniformly distributed in an address space. But, it is difficult to obtain such a hash function. Therefore, a case may occur in which many sets of keys and data are associated with an address whereas no set of keys and data is associated with other addresses.

Technologies, such as open hashing and closed hashing, can be used to store keys and data even when such address coincidence occurs.

When technologies such as open hashing are used, even if address coincidence occurs to some extent, it is possible to store keys and data. Even when technologies such as open hashing are used, however, if address coincidence occurs more than some extent, it is impossible to store keys and data. Therefore, the storage area cannot be effectively used.

Accordingly, an object of the present invention is to provide a semiconductor apparatus capable of using the storage area effectively.

### SUMMARY

To solve the forgoing problem, a semiconductor apparatus according to the present invention is a semiconductor apparatus for storing a key and data, including first to N-th (N is a natural number equal to or greater than two) storage sections having first to N-th storage capacities, respectively, for storing an externally-input key or data at a received address in key-and-data writing; and when a key and data are stored at a received address, for outputting the key and data and, when a key or data is not stored at a received address, for outputting a first signal indicating that a key or data is not stored at the received address, in key-and-data reading; first to N-th comparison sections for comparing the externally input key with keys output from the first to N-th storage sections, and when the externally input key matches the keys output from the first to N-th storage sections, for outputting a second signal indicating that the externally input key matches the keys output from the first to N-th storage sections, and when the first to N-th storage sections output the first signals, for outputting a third signal indicating that the first to N-th storage sections output the first signals, in key-and-data writing into the first to N-th storage sections; and for comparing the externally input key with keys output from the first to N-th storage sections, and when the externally input key matches the keys output from the first to N-th storage sections, for externally outputting data output from a storage section which outputs the key that matches the externally input key, among the first to N-th storage sections, in key-and-data reading from the first to N-th storage sections; a first calculation section for performing a first calculation which associates the externally input key with a first address in many-to-one correspondence; a second calculation section for performing a second calculation which associates the first address with a second address in one-to-one correspondence; a first processing section operating when a key and data are written, for sending the first address to the first to N-th storage sections; when the second signal is received from the M-th (M is a natural number equal to or less than N) comparison section, for storing the externally input data at the first address in the M-th storage section; when the second signal is not received from any of the first to N-th comparison sections and the third signal is received from one or more of the first to N-th comparison sections, for storing the externally input key and data at the first address in the first storage section obtained when a storage section or storage sections that output the first signal among the first to N-th storage sections are arranged in a first order; when the second signal is not received from any of the first to N-th comparison sections and the third signal is not received from any of the first to N-th comparison sections, for sending the second address to the first to N-th storage sections; when the second signal is received from the L-th (L is a natural number equal to or less than N) comparison section, for storing the externally input data at the second address in the L-th storage section; and when the second signal is not received from any of the first to N-th comparison sections and the third signal is received from one or more of the first to N-th comparison sections, for storing the externally input key and data at the second address in the first storage section obtained when a storage section or storage sections that output the first signal among the first to N-th storage sections are arranged in a second order; and a second processing section operating when data is read, for sending the first address to the first to N-th storage sections; and when the second signal is not received from any of the first to N-th comparison sections, for sending the second address to the first to N-th storage sections.

With the above-described structure, the storage area can be used effectively.

### BRIEF DESCRIPTION OF THE DRAWINGS

FIG. 1 is a view showing the structure of a semiconductor apparatus according to an embodiment of the present invention.

FIG. 2 is a view showing data stored in memories 6 to 10 shown in FIG. 1.

FIG. 3 is a view showing data stored in the memories 6 to 10 shown in FIG. 1.

FIG. 4 is a view showing data stored in the memories 6 to 10 shown in FIG. 1.

FIG. 5 is a view showing data stored in the memories 6 to 10 shown in FIG. 1.

FIG. 6 is a view showing data stored in the memories 6 to 10 shown in FIG. 1.

FIG. 7 is a view showing data stored in the memories 6 to 10 shown in FIG. 1.

FIG. 8 is a view showing an exemplary ratio of the storage capacities of the memories 6 to 10.

### DETAILED DESCRIPTION

An embodiment of the present invention will be described below by referring to the drawings.

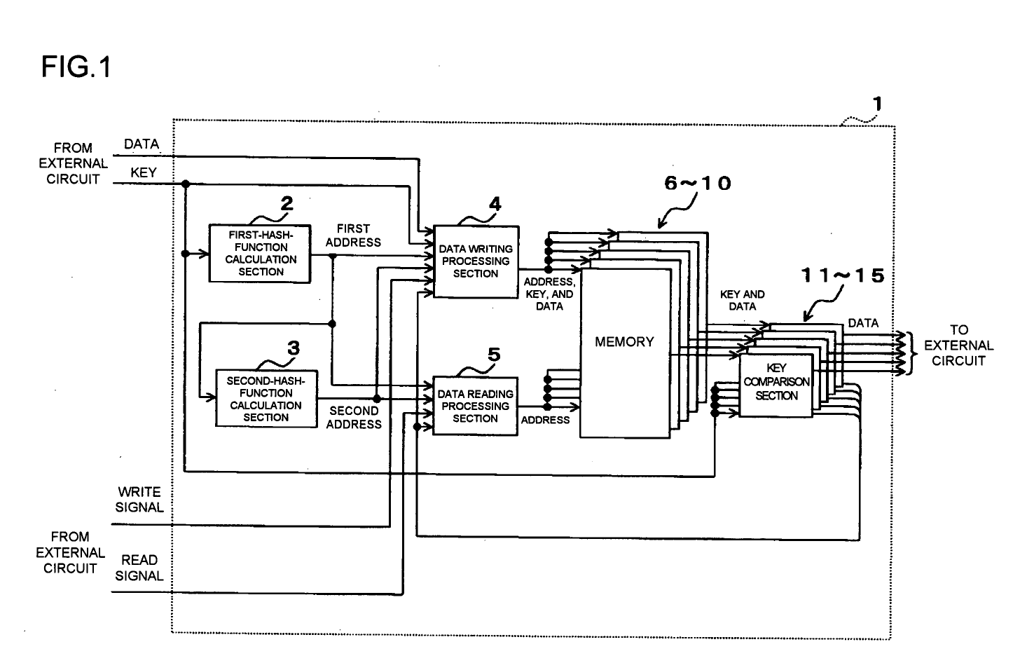

FIG. 1 is a view showing a semiconductor apparatus according to an embodiment of the present invention. As shown in FIG. 1, the semiconductor apparatus 1 is provided with a first-hash-function calculation section 2, a second-hash-function calculation section 3, a data writing processing section 4, a data reading processing section 5, memories 6 to 10, and key comparison sections 11 to 15.

A key is input from an external circuit to the first-hash-function calculation section 2. The first-hash-function calculation section 2 performs a calculation of a first hash function:

y=hash1(x) (1)

which associates the input key with a first address in many-to-one correspondence. In expression (1), “x” indicates the input key, and “y” indicates the first address. The first-hash-function calculation section 2 sends the first address calculated from the input key, to the second-hash-function calculation section 3, to the data writing processing section 4, and to the data reading processing section 5.

The second-hash-function calculation section 3 performs a calculation of a second hash function:

y=hash2(x) (2)

which associates the first address with a second address in one-to-one correspondence. In expression (2), “x” indicates the first address, and “y” indicates the second address. The second-hash-function calculation section 3 sends the second address calculated from the first address, to the data writing processing section 4 and to the data reading processing section 5. In the second hash function, the input “x” (first address) does not match the output “y” (second address). As the second hash function, a function which inverts the most significant bit (MSB) of the key and then Gray-Code-converts the key or others can be used.

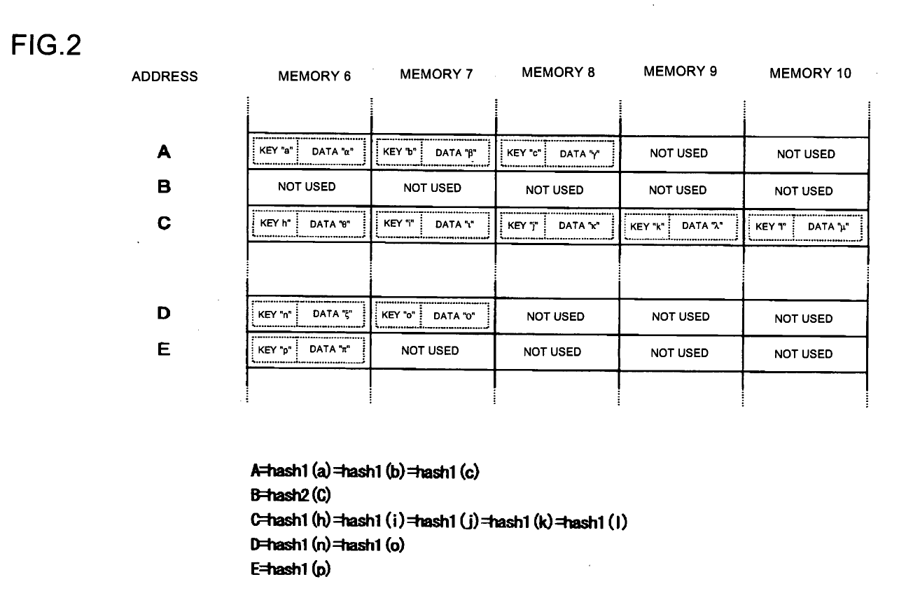

In a data writing operation in the semiconductor apparatus 1, the external circuit inputs a key to the first-hash-function calculation section 2, to the data writing processing section 4, and to the key comparison sections 11 to 15, and inputs data and a write signal to the data writing processing section 4. The data writing operation in the semiconductor apparatus 1 will be described below by referring to FIG. 2 to FIG. 7. FIG. 2 to FIG. 7 show keys and data stored in the memories 6 to 10.

The memories 6 to 10 have the same storage capacity, and are mapped onto the same address space. It is assumed in the present embodiment that a key “a” and data “α” are stored at an address “A” in the memory 6, a key “b” and data “β” are stored at the address “A” in the memory 7, and a key “c” and data “γ” are stored at the address “A” in the memory 8, as shown in FIG. 2. In addition, it is assumed that a key “h” and data “θ” are stored at an address “C” in the memory 6, a key “i” and data “ι” are stored at the address “C” in the memory 7, a key “j” and data “κ” are stored at the address “C” in the memory 8, a key “k” and data “λ” are stored at the address “C” in the memory 9, a key “l” and data “μ” are stored at the address “C” in the memory 10. Further, it is assumed that a key “n” and data “ξ” are stored at an address “D” in the memory 6, a key “o” and data “∘” are stored at the address “D” in the memory 7, and a key “p” and data “π” are stored at an address “E” in the memory 6.

A=hash1(a)=hash1(b)=hash1(c) (3)

C=hash1(h)=hash1(i)=hash1(j)=hash1(k)=hash1(l) (4)

D=hash1(n)=hash1(o) (5)

E=hash1(p) (6)

When the external circuit inputs a key “d” which satisfies the following expressions, data “δ”, and a write signal to the semiconductor apparatus 1,

A=hash1(d) (7)

D=hash2(A) (8)

the first-hash-function calculation section 2 outputs the address “A” serving as a first address to the second-hash-function calculation section 3 and to the data writing processing section 4, and the second-hash-function calculation section 3 outputs the address “D” serving as a second address to the data writing processing section 4.

When the data writing section 4 receives the addresses “A” and “D”, it first outputs the address “A” to the memories 6 to 10.

When the memories 6 to 8 receive the address “A”, they output the keys “a” to “c” to the key comparison sections 11 to 13, respectively. When the memories 9 and 10 receive the address “A”, they output a first signal (“0xfff”, for example) indicating that a key or data is not stored, to the key comparison sections 14 and 15, respectively.

In a data writing operation, the key comparison sections 11 to 15 compare the key input from the external circuit with the keys output from the memories 6 to 10, respectively, to determine whether they match. When they match, the key comparison sections 11 to 15 output a second signal indicating that the keys have matched, to the data writing operation section 4 and to the data reading operation section 5. Since the key “d” input from the external circuit does not match the keys “a” to “c” output from the memories 6 to 8, the key comparison sections 11 to 13 do not output the second signal. The key comparison sections 14 and 15 output a third signal indicating that a key or data is not stored at the address “A” in the memories 9 and 10 to the data writing processing section 4, respectively.

When the data writing processing section 4 receives the second signal from any of the key comparison sections 11 to 15 after it outputs the first address (the address “A” in this case), the data writing processing section 4 writes (over-writes) the data “δ” at the address A in the memory which has stored the key “d” among the memories 6 to 10. When the data writing processing section 4 does not receive the second signal from any of the key comparison sections 11 to 15 but receives the third signal from one or more of the key comparison sections 11 to 15, the data writing processing section 4 stores the key “d” and the data “δ” at the address “A” in the memory which outputs the first signal, checked first among the memories 6 to 10 in the order from the memory 6 to the memory 10.

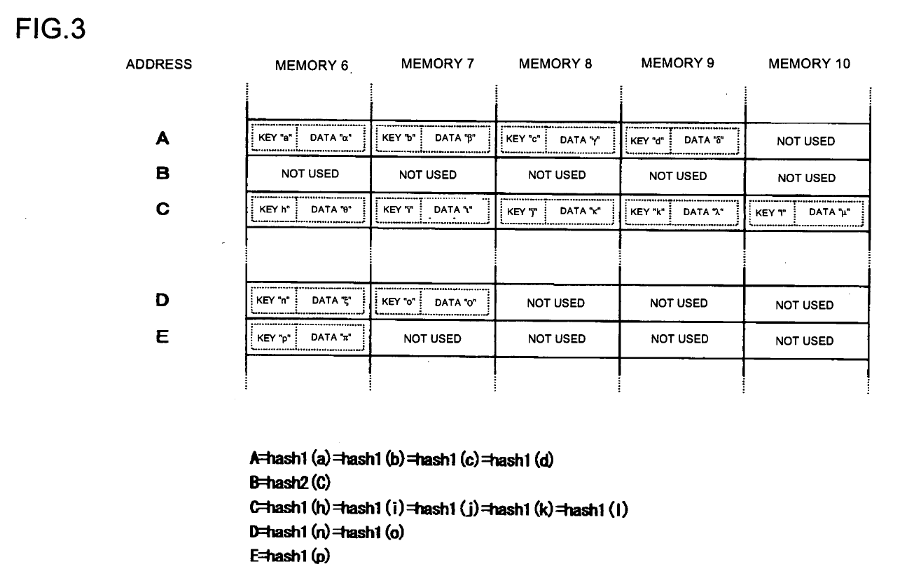

In the present embodiment, none of the key comparison sections 11 to 13 outputs the second signal, and each of the key comparison sections 14 and 15 outputs the third signal, the data writing processing section 4 stores the key “d” and the data “δ” at the address “A” in the memory 9. FIG. 3 is a view showing that the key “d” and the data “δ” have been stored at the address “A” in the memory 9.

Next, when the external circuit inputs a key “e” which satisfies the following expressions, data “ε”, and a write signal to the semiconductor apparatus 1,

A=hash1 (e) (9)

D=hash2(A) (10)

the first-hash-function calculation section 2 outputs the address “A” serving as a first address to the second-hash-function calculation section 3 and to the data writing processing section 4, and the second-hash-function calculation section 3 outputs the address “D” serving as a second address to the data writing processing section 4.

When the data writing section 4 receives the addresses “A” and “D”, it first outputs the address “A” to the memories 6 to 10.

When the memories 6 to 9 receive the address “A”, they output the keys “a” to “d” to the key comparison sections 11 to 14, respectively. When the memory 10 receives the address “A”, it outputs the first signal to the key comparison section 15.

Since the key “e” input from the external circuit does not match the keys “a” to “d” output from the memories 6 to 9, the key comparison sections 11 to 14 do not output the second signal. The key comparison section 15 outputs the third signal to the data writing processing section 4.

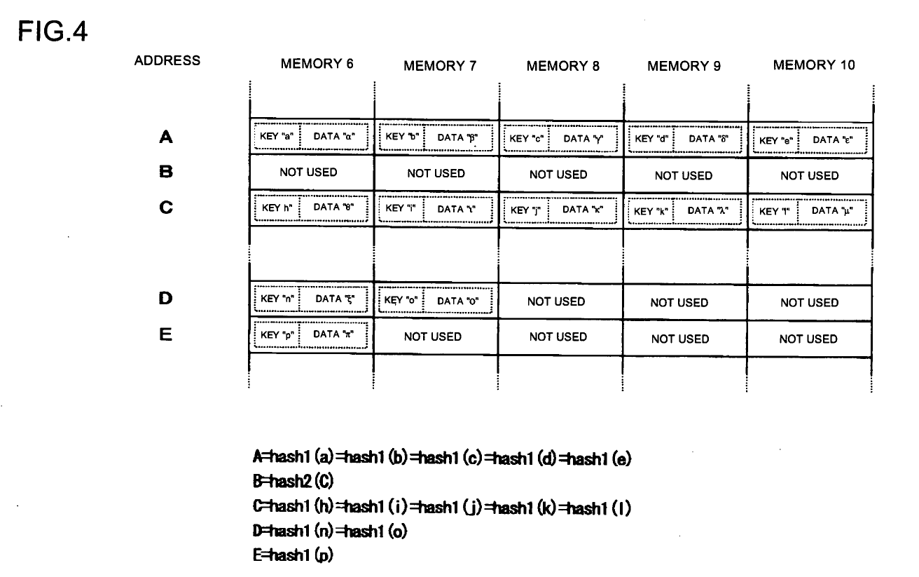

Since none of the key comparison sections 11 to 14 outputs the second signal, and the key comparison section 15 outputs the third signal, the data writing processing section 4 stores the key “e” and the data “ε” at the address “A” in the memory 10. FIG. 4 is a view showing that the key “e” and the data “ε” have been stored at the address “A” in the memory 10.

Next, when the external circuit inputs a key “f” which satisfies the following expressions, data “ζ”, and a write signal to the semiconductor apparatus 1,

A=hash1(f) (11)

D=hash2(A) (12)

the first-hash-function calculation section 2 outputs the address “A” to the second-hash-function calculation section 3 and to the data writing processing section 4, and the second-hash-function calculation section 3 outputs the address “D” to the data writing processing section 4.

When the data writing section 4 receives addresses “A” and “D”, it first outputs the address “A” to the memories 6 to 10.

When the memories 6 to 10 receive the address “A”, they output the keys “a” to “e” to the key comparison sections 11 to 15, respectively.

Since the key “f” input from the external circuit does not match the keys “a” to “e” output from the memories 6 to 10, the key comparison sections 11 to 15 do not output the second signal.

Since none of the key comparison sections 11 to 15 outputs the second signal or the third signal, the data writing processing section 4 outputs the address “D” to the memories 6 to 10.

When the memories 6 and 7 receive the address “D”, they output the keys “n” and “o” to the key comparison sections 11 and 12, respectively. When the memories 8 to 10 receive the address “D”, they output the first signals to the key comparison sections 13 to 15, respectively.

Since the key “f” input from the external circuit does not match the key “n” or the key “o” output from the memory 6 or 7, neither of the key comparison sections 11 and 12 outputs the second signal. The key comparison sections 13 to 15 output the third signals to the data writing processing section 4.

When the data writing processing section 4 outputs the second address (address “D” in this case), if the data writing processing section 4 receives the second signal from any of the key comparison sections 11 to 15, the data writing processing section 4 stores (overwrites) the data “ζ” at the address “A” in the memory which has stored the key “f” among the memories 6 to 10. If the data writing processing section 4 does not receive the second signal from any of the key comparison sections 11 to 15 but receives the third signal from one or more of the key comparison sections 11 to 15, the data writing processing section 4 stores the key “f” and the data “ζ” at the address “D” in the memory which outputs the first signal, checked first among the memories 6 to 10 in the order from the memory 10 to the memory 6.

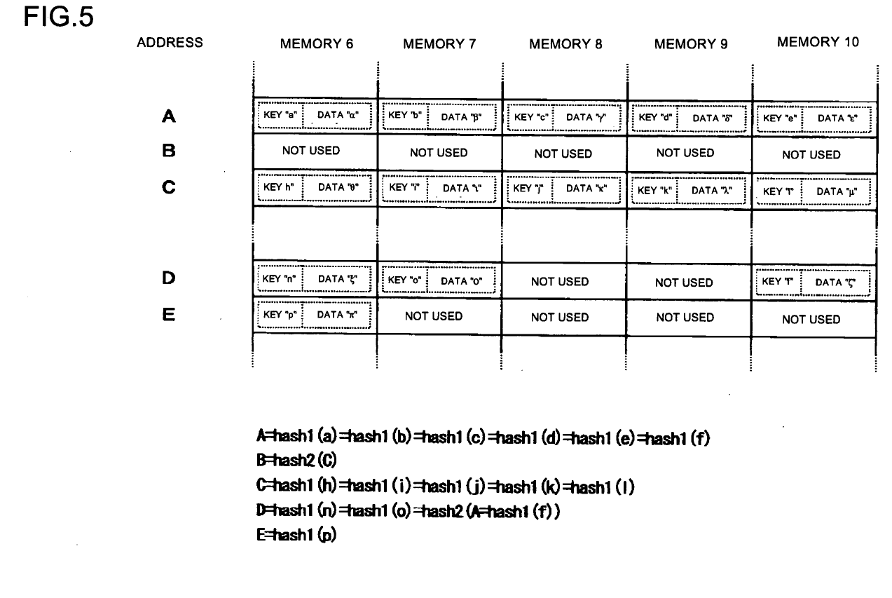

In the present embodiment, since neither of the key comparison sections 11 and 12 outputs the second signal, and the key comparison sections 13 to 15 output the third signals, the data writing processing section 4 stores the key “f” and the data “ζ” at the address “D” in the memory 10. FIG. 5 is a view showing that the key “f” and the data “ζ” have been stored at the address “D” in the memory 10.

Next, when the external circuit inputs a key “g” which satisfies the following expressions, data “η”, and a write signal to the semiconductor apparatus 1,

A=hash1(g) (13)

D=hash2(A) (14)

the first-hash-function calculation section 2 outputs the address “A” serving as the first address to the second-hash-function calculation section 3 and to the data writing processing section 4, and the second-hash-function calculation section 3 outputs the address “D” serving as the second address to the data writing processing section 4.

When the data writing section 4 receives the addresses “A” and “D”, it first outputs the address “A” to the memories 6 to 10.

When the memories 6 to 10 receive the address “A”, they output the keys “a” to “e” to the key comparison sections 11 to 15, respectively.

Since the key “g” input from the external circuit does not match the keys “a” to “e” output from the memories 6 to 10, the key comparison sections 11 to 15 do not output the second signal.

Since none of the key comparison sections 11 to 15 outputs the second signal, the data writing processing section 4 outputs the address “D” to the memories 6 to 10.

When the memories 6, 7, and 10 receive the address “D”, they output the keys “n”, “o”, and “f” to the key comparison sections 11, 12, and 15, respectively. When the memories 8 and 9 receive the address “D”, they output the first signals to the key comparison sections 13 and 14, respectively.

Since the key “g” input from the external circuit does not match the key “n”, the key “o”, or the key “f” output from the memory 6, 7, or 10, none of the key comparison sections 11, 12, and 15 outputs the second signal. The key comparison sections 13 and 14 output the third signals.

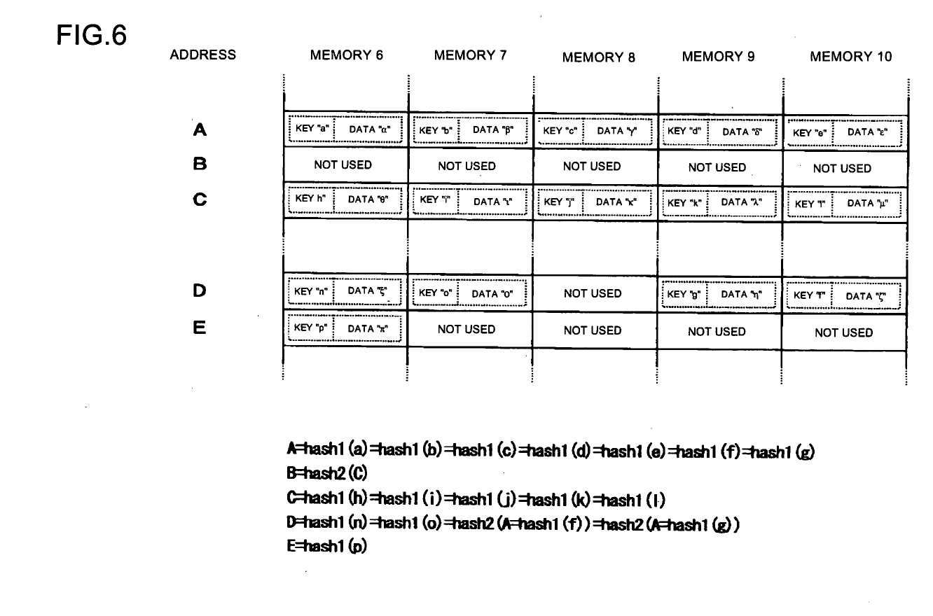

Since none of the key comparison sections 11, 12, and 15 outputs the second signal, and the key comparison sections 13 and 14 output the third signals, the data writing processing section 4 stores the key “g” and the data “η” at the address “D” in the memory 9. FIG. 6 is a view showing that the key “g” and the data “η” have been stored at the address “D” in the memory 9.

Next, when the external circuit inputs a key “m” which satisfies the following expressions, data “v”, and a write signal to the semiconductor apparatus 1,

C=hash1(m) (15)

B=hash2(C) (16)

the first-hash-function calculation section 2 outputs the address “C” serving as the first address to the second-hash-function calculation section 3 and to the data writing processing section 4, and the second-hash-function calculation section 3 outputs the address “B” serving as the second address to the data writing processing section 4.

When the data writing section 4 receives addresses “C” and “B”, it first outputs the address “C” to the memories 6 to 10.

When the memories 6 to 10 receive the address “C”, they output the keys “h” to “l” to the key comparison sections 11 to 15, respectively.

Since the key “m” input from the external circuit does not match the keys “h” to “l” output from the memories 6 to 10, the key comparison sections 11 to 15 do not output the second signal.

Since none of the key comparison sections 11 to 15 outputs the second signal, the data writing processing section 4 outputs the address “B” to the memories 6 to 10.

When the memories 6 to 10 receive the address “B”, they output the first signals to the key comparison sections 11 to 15, respectively.

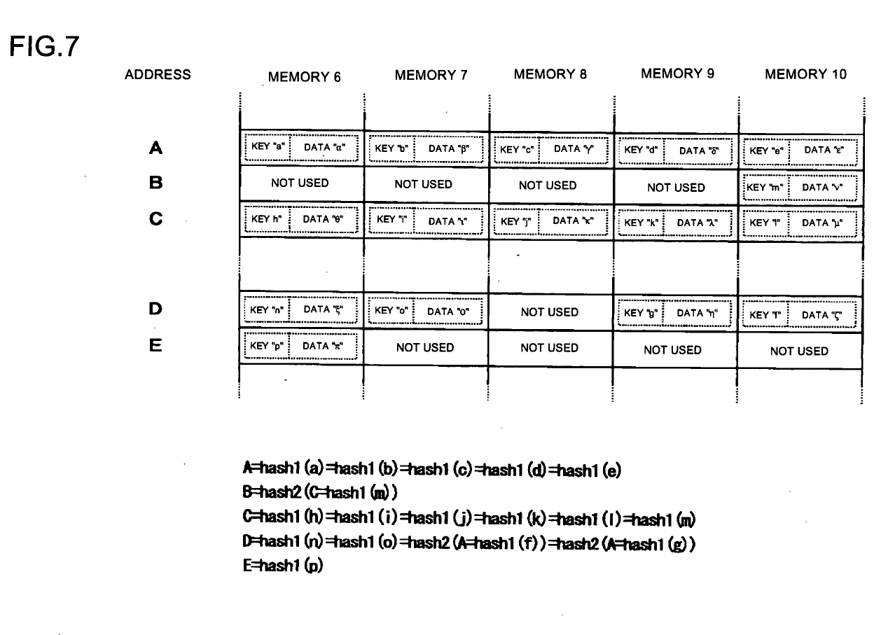

Since none of the key comparison sections 11 to 15 outputs the second signal but they output the third signals, the data writing processing section 4 stores the key “m” and the data “ν” at the address “B” in the memory 10. FIG. 7 is a view showing that the key “m” and the data “ν” have been stored at the address “B” in the memory 10.

A data reading operation in the semiconductor apparatus will be described next. A case in which the data “η” stored at the address. “D” in the memory 9, as shown in FIG. 7, is read will be described.

In a data reading operation in the semiconductor apparatus 1, the external circuit inputs a key to the first-hash-function calculation section 2, and to the key comparison sections 11 to 15, and inputs a read signal to the data reading processing section 5. When the key “g” is input, the first-hash-function calculation section 2 outputs the address “A” serving as the first address to the second-hash-function calculation section 3 and to the data reading processing section 5, and the second-hash-function calculation section 3 outputs the address “D” serving as the second address to the data reading processing section 5.

When the data reading section 5 receives the addresses “A” and “D”, it first outputs the address “A” to the memories 6 to 10.

When the memories 6 to 10 receive the address “A”, they output the keys “a” to “e” and the data “α” to “ε” to the key comparison sections 11 to 15, respectively.

In a data reading operation, the key comparison sections 11 to 15 compare the key input from the external circuit with the keys output from the memories 6 to 10, respectively, to determine whether they match. When they match, the key comparison sections 11 to 15 output the second signals to the data reading operation section 5, and the data associated with the matched key to the external circuit. Since the key “g” input from the external circuit does not match the keys “a” to “e” output from the memories 6 to 10, the key comparison sections 11 to 15 do not output the second signal. None of the data “α” to “ε” is output to the external circuit.

When the data reading processing section 5 receives the second signal from any of the key comparison sections 11 to 15, it terminates the processing. In the present embodiment, since none of the key comparison sections 11 to 15 outputs the second signal, the data reading processing section 5 outputs the address “D” to the memories 6 to 10.

When the memories 6, 7, 9, and 10 receive the address “D”, they output the key “n” and the data “ξ”, the key “o” and the data “∘”, the key “g” and the data “η”, and the key “f” and the data “ζ” to the key comparison sections 11, 12, 14, and 15, respectively. When the memory 8 receives the address “D”, it outputs the first signal to the key comparison section 13.

Since the key “g” input from the external circuit matches the key “g” output from the memory 9, the key comparison section 14 outputs the second signal to the data reading processing section 5, and outputs the data “η” to the external circuit.

When the data reading processing section 5 receives the second signal from the key comparison section 14, it terminates the processing.

In this way, according to the present embodiment, the memories 6 to 10 are effectively used. According to a result of computer simulation, the rate of use of a memory is about 60% in the conventional technology, but it is about 90% in the memories 6 to 10 in the present embodiment.

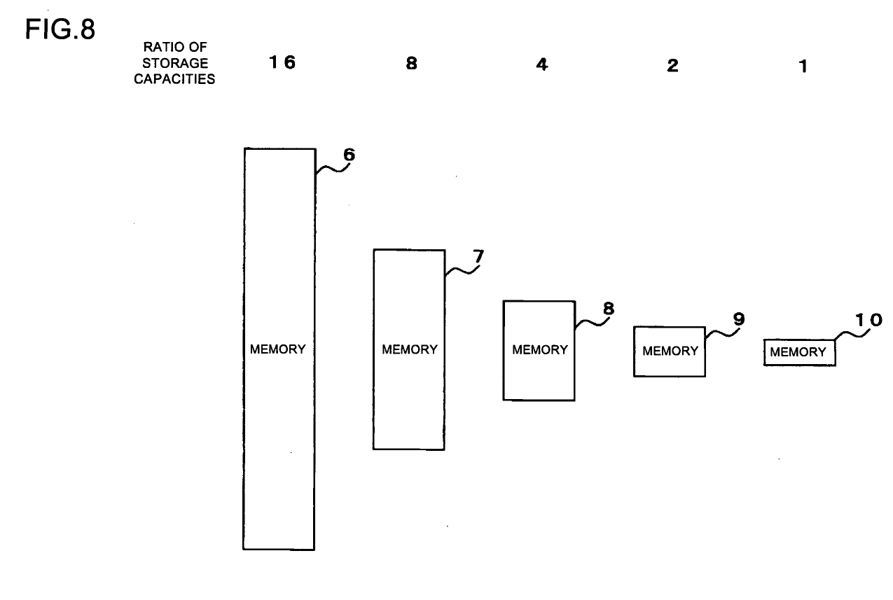

In the present embodiment, the memories 6 to 10 have the same storage capacity. As shown in FIG. 8, the ratio of the storage capacities of the memories 6 to 10 may be set to 16:8:4:2:1. Alternatively, other ratios may be used.

The entire disclosure of Japanese Patent Application No. 2003-002831 filed Jan. 9, 2003 is incorporated by reference.

What is claimed is:

1. A semiconductor apparatus for storing a key and data, comprising:
first to N-th (N is a natural number equal to or greater than two) storage sections having first to N-th storage capacities, respectively, the storage sections:
storing an externally-input key or data at a received address in key-and data writing; and
when a key and data are stored at a received address, outputting the key and data; and
when a key or data is not stored at a received address, outputting a first signal indicating that a key or data is not stored at the received address, in key-and-data reading;
first to N-th comparison sections, the comparison sections:
comparing the externally input key with keys output from the first to N-th storage sections; and
when the externally input key matches the keys output from the first to N-th storage sections, outputting a second signal indicating that the externally input key matches the keys output from the first to N-th storage sections; and
when the first to N-th storage sections output the first signals, outputting a third signal indicating that the first to N-th storage sections output the first signals, in key-and-data writing into the first to N-th storage sections; and
comparing the externally input key with keys output from the first to N-th storage sections; and
when the externally input key matches the keys output from the first to N-th storage sections, externally outputting data output from a storage section which outputs the key that matches the externally input key, among the first to N-th storage sections, in key-and-data reading from the first to N-th storage sections;
a first calculation section performing a first calculation which associates the externally input key with a first address in many-to-one correspondence;
a second calculation section performing a second calculation which associates the first address with a second address in one-to-one correspondence;
a first processing section operating when a key and data are written, the first processing section:
sending the first address to the first to N-th storage sections; and
when the second signal is received from the M-th (M is a natural number equal to or less than N) comparison section, storing the externally input data at the first address in the M-th storage section;
when the second signal is not received from any of the first to N-th comparison sections and the third signal is received from one or more of the first to N-th comparison sections, storing the externally input key and data at the first address in the first storage section obtained when a storage section or storage sections that output the first signal among the first to N-th storage sections are arranged in a first order;
when the second signal is not received from any of the first to N-th comparison sections and the third signal is not received from any of the first to N-th comparison sections, sending the second address to the first to N-th storage sections;
when the second signal is received from the L-th (L is a natural number equal to or less than N) comparison section, storing the externally input data at the second address in the L-th storage section; and
when the second signal is not received from any of the first to N-th comparison sections and the third signal is received from one or more of the first to N-th comparison sections, storing the externally input key and data at the second address in the first storage section obtained when a storage section or storage sections that output the first signal among the first to N-th storage sections are arranged in a second order; and
a second processing section operating when data is read, the second processing section:
sending the first address to the first to N-th storage sections; and
when the second signal is not received from any of the first to N-th comparison sections, sending the second address to the first to N-th storage sections.
